(19) United States
(12) Patent Application Publication
(10) Pub. No.: US 2026/0369547 A1
(43) Pub. Date: Nov. 19, 2026

(54) METHOD FOR MANUFACTURING ELECTRODE SHEET AND ELECTRODE SHEET MANUFACTURED THEREBY

(71) Applicant: SK On Co., Ltd., Seoul (KR)

(72) Inventors: Seung Yeon JO, Daejeon (KR); Sung Jun PARK, Daejeon (KR); Kyu Sik LEE, Daejeon (KR); Young Jun KIM, Daejeon (KR); Seung Hyeon OH, Daejeon (KR); Hye Won HWANG, Daejeon (KR)

(21) Appl. No.: 19/676,805

(22) Filed: May 14, 2026

(30) Foreign Application Priority Data
May 15, 2025 (KR) 10-2025-0063211

(51) Int. Cl. H01M 4/04; H01M 4/02

(52) U.S. Cl. CPC H01M 4/0435; H01M 2004/021

(57) ABSTRACT

The present disclosure relates to a method for manufacturing an electrode sheet, the method including manufacturing electrode powder with first fiberization by mixing an electrode active material, a conductive material, and a binder using a mixing device, manufacturing a first electrode sheet by inputting the electrode powder into a plurality of rolls at a first interval of about 1 mm or more, and manufacturing a second electrode sheet by inputting the first electrode sheet onto the plurality of rolls set at a second interval of about 200 μm or less, which is narrower than the first interval, and an electrode sheet manufactured thereby.

### CROSS-REFERENCE TO RELATED PATENT APPLICATION

The present application claims priority under 35 U.S.C. § 119(a) to Korean patent application number 10-2025-0063211, filed on May 15, 2025, in the Ministry of Intellectual Property, the entire disclosure of which is incorporated by reference herein.

### BACKGROUND OF THE INVENTION

### 1. Field

The present disclosure relates to a method for manufacturing an electrode sheet and an electrode sheet manufactured thereby.

### 2. Description of the Related Art

Generally, an electrode of a lithium secondary battery is manufactured by dispersing an electrode active material, a conductive material, and a binder in a solvent to form slurry, applying the slurry onto a current collector, and then drying the slurry to evaporate the solvent.

Recently, a method for manufacturing an electrode in a dry manner has been proposed. The method for manufacturing the electrode in the dry manner is a method that does not use a solvent, and thus, a drying process for removing the solvent may be omitted. However, the electrode manufactured by this conventional dry method have insufficient tensile strength, and there is a limitation of cracks occurring on its surface.

Thus, there is a high need for a technology that is capable of ensuring the tensile strength of the electrode when manufacturing the electrode in the dry method.

### SUMMARY OF THE INVENTION

An object of the present disclosure is to improve quality of an electrode sheet.

Another object of the present disclosure is to quantify fiberization of electrode powder.

Another object of the present disclosure is to simplify a process of manufacturing an electrode sheet.

Another object of the present disclosure is to improve properties of an electrode sheet.

Another object of the present disclosure is to increase in tensile strength of an electrode sheet.

Another object of the present disclosure is to reduce manufacturing costs of an electrode sheet.

The present disclosure may be widely applied in fields of green technologies such as electric vehicles, battery charging stations, solar power generation, wind power generation, etc., which use batteries. Furthermore, the present disclosure may be used in eco-friendly electric vehicles, hybrid vehicles, etc., in order to prevent climate change by suppressing air pollution and greenhouse gas emission.

A method for manufacturing an electrode sheet according to an embodiment of the present invention includes: manufacturing electrode powder with first fiberization by mixing an electrode active material, a conductive material, and a binder using a mixing device; manufacturing a first electrode sheet by inputting the electrode powder into a plurality of rolls at a first interval of about 1 mm or more; and manufacturing a second electrode sheet by inputting the first electrode sheet onto the plurality of rolls at a second interval of about 200 μm or less, which is narrower than the first interval.

In an embodiment, the first fiberization may be determined by a flow function of the electrode powder.

In an embodiment, the flow function may include more than about 0 to about 1.4 or less.

In an embodiment, the first fiberization may be determined by cohesion strength of the electrode powder.

In an embodiment, the cohesion strength may include about 300 Pa or more and less than about 700 Pa.

In an embodiment, the first fiberization may be determined by shear force applied to the electrode powder by the mixing device.

In an embodiment, the mixing device may include a kneader, and the manufacturing of the electrode powder may include mixing the electrode active material, the conductive material, and the binder at a first temperature, at a first speed, and for a first time by using the kneader.

In an embodiment, the first temperature may range of about 20 °C to about 150 °C, the first speed may range of about 5 rpm to about 100 rpm, and the first time may range of about 30 seconds to about 10 minutes.

In an embodiment, the mixing device may include a batch mixer, and the manufacturing of the electrode powder may include mixing the electrode active material, the conductive material, and the binder at a second temperature, at a second speed, and for a second time by using the batch mixer.

In an embodiment, the second temperature may range of about 20 °C to about 80 °C, the second speed may range of about 5,000 rpm to about 10,000 rpm, and the second time may range of about 1 minute to about 10 minutes.

In an embodiment, with respect to 100 parts by weight of the electrode powder, the electrode active material may have about 93 parts to about 97 parts by weight, the conductive material may have about 2 parts to about 4 parts by weight, and the binder may have about 1 part to about 3 parts by weight.

In an embodiment, the first interval may range from about 1 mm or more to about 5 mm or less.

In an embodiment, the second interval may range from about 50 μm or more to about 200 μm or less.

An electrode sheet according to another embodiment of the present invention is manufactured according to the above-described method.

In an embodiment, the electrode sheet may be manufactured by processing electrode powder having first fiberization into a sheet form, wherein the first fiberization may be determined by one or more of flow function of the electrode powder and cohesion strength of the electrode powder, wherein the flow function may range of more than about 0 to about 1.4 or less, and the cohesion strength may range of about 300 Pa or more and less than about 700 Pa.

### BRIEF DESCRIPTION OF THE DRAWINGS

FIG. 1 is a schematic block diagram illustrating a system for manufacturing an electrode sheet according to the present disclosure.

FIG. 2 is a graph for explaining a flow function and cohesion strength.

FIG. 3A is a schematic view illustrating a calendering device for explaining a process of manufacturing a first electrode sheet.

FIG. 3B is a schematic view illustrating the calendering device for explaining a process of manufacturing a second electrode sheet.

FIG. 4 is a flowchart illustrating a method for manufacturing an electrode sheet using a system for manufacturing the electrode sheet according to the present disclosure.

FIG. 5 is a graph for explaining a correlation between types of a mixing device and a flow function.

FIG. 6 is a graph for explaining a correlation between a particle size and the flow function of electrode powder.

FIG. 7 is a graph for explaining a correlation between a measured temperature and the flow function of electrode powder.

### DETAILED DESCRIPTION

Preferred embodiments of the present disclosure will be described below in more detail with reference to the accompanying drawings. A configuration or control method of the device described below is only for explaining embodiments of the present disclosure and is not intended to limit the scope of the present disclosure, and the same reference numbers used throughout the specification indicate the same components.

The use of the terms such as ‘first, second, and third’ in front of the components mentioned below is only to avoid confusion about the components to which they are referred, as well as has nothing to do with the order, importance, or master-slave relationship between the components. For example, the invention that includes only the second component without the first component can also be implemented.

As used herein, the terms of a singular form may include plural forms unless referred to the contrary.

The numerical ranges used in this specification include all values within the lower and upper limit values, increments logically derived from the form and breadth of the defined range, all values that are double-limited, and all possible combinations of the upper and lower limit values of the numerical range limited in different forms.

Unless otherwise specifically defined in this specification, “about” may be considered as within 30%, 25%, 20%, 15%, 10%, or 5% of the specified value.

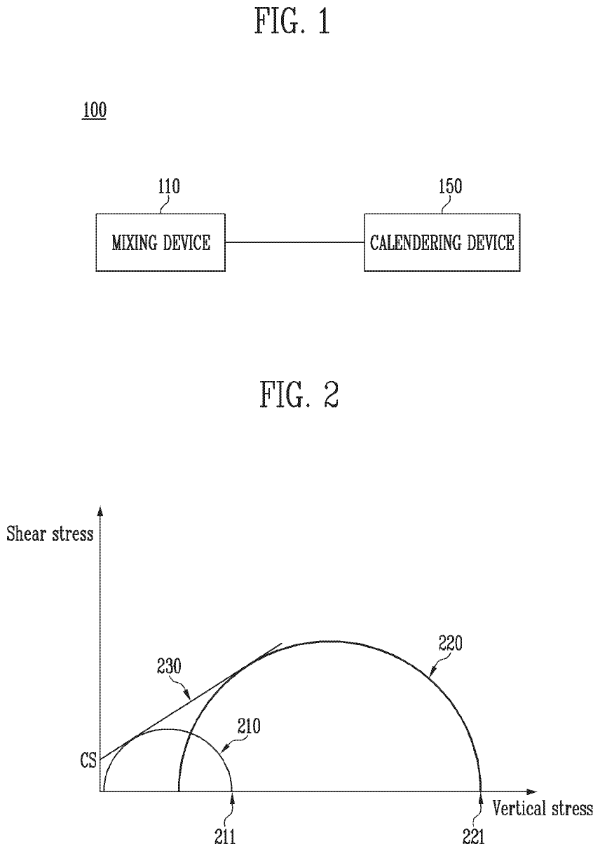

FIG. 1 is a schematic block diagram illustrating a system for manufacturing an electrode sheet according to the present disclosure.

Referring to FIG. 1, a system 100 for manufacturing an electrode sheet according to the present disclosure may include a mixing device 110 that manufactures electrode powder having preset fiberization (hereinafter, referred to as first fiberization), and a calendering device 150 that obtains a dry electrode sheet from the electrode powder.

In this disclosure, the electrode powder may be manufactured by mixing a mixture including an electrode active material, a binder capable of being fibrous, and a conductive material. In particular, when mixing the mixture, shear stress may be applied to accelerate the fiberization of the binder, thereby bonding particles of the electrode active material to each other.

In this disclosure, the electrode sheet may be manufactured by performing a first calendering process and a second calendering process after the first calendering process on the electrode powder having high fiberization. When performing the first calendaring process, an interval spaced between rolls included in the calendaring device 150 may be set to be larger than an interval spaced between the rolls when performing the second calendaring process. When a degree of progression of fiberization of the binder is high, it may be difficult to insert the electrode powder between the rolls. Thus, when performing the calendering process once, the interval between the rolls may be set relatively large. Subsequently, when performing the second coalescing process, the interval between the rolls may be set relatively narrow in order to accelerate the fiberization by applying heat and/or a pressure to the electrode powder. The one calendering process may be referred to as a pre-sheeting process.

As a result, the heat and/or pressure may be applied to the electrode powder to fiberize the binder, thereby enabling the manufacture of the dry electrode sheet that is maintained in its sheet shape without a separate support such as a current collector and has high tensile strength. The electrode sheet of the present disclosure may be referred to as a free standing electrode sheet or a self-supporting electrode sheet.

The present disclosure may also be equally applied to a direct lamination method in which a mixture including an electrode active material, binder, and conductive material is transferred onto a current collector to manufacture a dry electrode sheet. That is, the electrode sheet including the current collector on which the mixture has been transferred may be manufactured, and the electrode sheet may be manufactured by performing the first calendering process and the second calendering process after the first calendering process to fiberize the binder.

Thus, a drying process of drying a solvent may be omitted, and an environmentally friendly electrode sheet may be manufactured.

Hereinafter, a method for manufacturing the electrode powder having the first fiberization will be described.

In an embodiment, the mixing device 110 may mix the electrode active material, the binder, and the conductive material to manufacture the electrode powder having the first fiberization. The electrode powder may represent a powdery aggregate including mixed particles of the electrode active material, the binder, and the conductive material.

With respect to 100 parts by weight of the electrode powder, the electrode active material may be about 80 parts by weight to about 98 parts by weight. If an amount of the electrode active material is less than about 80 parts by weight, capacity characteristics of a secondary battery may be poor, which is problematic. If the amount exceeds about 98 parts by weight, mechanical strength of the electrode sheet may be low, which may also be problematic. In detail, the electrode active material may be about 85 parts by weight to about 98 parts by weight, or about 90 parts by weight to about 98 parts by weight, with respect to 100 parts by weight of the electrode powder.

With respect to 100 parts by weight of the electrode powder, the conductive material may be about 1 part by weight to about 5 parts by weight. The conductive material may be contained within the above-described range to effectively transfer ions within the electrode sheet. Particularly, the conductive material may be about 1.5 parts by weight to about 5 parts by weight, or about 2 parts by weight to about 5 parts by weight with respect to 100 parts by weight of the electrode powder.

With respect to 100 parts by weight of the electrode powder, the binder may be about 0.5 parts by weight to about 3 part by weight. If the amount of the binder is less than about 0.5 parts by weight, the fiberization of the binder is not sufficiently performed, and thus, the binder may not stably bind the electrode active material. Since an amount of about 3 parts by weight is sufficient, when including more than about 3 parts by weight, production costs may unnecessarily increase. Particularly, the binder may be about 0.7 parts by weight to about 3 parts by weight, or about 0.9 parts by weight to about 3 parts by weight with respect to 100 parts by weight of the electrode powder.

More specifically, with respect to 100 parts by weight of the electrode powder, the electrode active material may be mixed in an amount of about 93 parts to about 97 parts by weight, the conductive material may be mixed in an amount of about 2 parts to 4 parts by weight, and the binder may be mixed in an amount of about 1 part to 3 parts by weight.

The electrode active material may refer to a negative electrode active material. As the negative electrode active material, a material capable of adsorbing and desorbing lithium ions may be used. For example, as the negative electrode active material, carbon-based materials such as crystalline carbon, amorphous carbon, carbon composites, and carbon fibers, lithium metals, lithium alloys, silicon (Si)-containing materials, or tin (Sn)-containing materials may be used.

Examples of the amorphous carbon may include hard carbon, soft carbon, coke, mesocarbon microbead (MCMB), and mesophase pitch-based carbon fiber (MPCF).

As examples of the crystalline carbon, carbonaceous carbons such as natural graphite, artificial graphite, graphitized coke, graphitized MCMB, and graphitized MPCF may be used.

The lithium metal may be a pure lithium metal or a lithium metal with a protective layer disposed to inhibit dendrite growth, etc. In an embodiment, a lithium metal-containing layer deposited or coated on the negative electrode current collector may be used as a negative electrode active material layer. In an embodiment, a lithium thin film layer may also be used as the positive electrode active material layer.

As elements contained in the lithium alloy, aluminum, zinc, bismuth, cadmium, antimony, silicon, lead, tin, gallium, or indium may be used.

The silicon-containing material may provide more increasing dose characteristics. The silicon-containing material may include Si, SiOₓ (0<x<2), metal-doped SiOₓ (0<x<2), silicon-carbon composites, etc. The metal may include lithium and/or magnesium, and the metal-doped SiOₓ (0<x<2) may include metal silicate.

The binder may be made of a material that is capable of being fibrous. The binder may be distributed on surfaces of the particles of the electrode active material to firmly bond the particles to each other, thereby providing the tensile strength to the electrode sheet and allowing the sheet to be maintained in its sheet shape. In addition, when manufacturing the electrode by laminating the dry electrode sheet on the surface of the electrode current collector, the electrode sheet may be firmly bonded to the surface of the electrode current collector.

The binder may be one or more selected from the group consisting of a polytetrafluoroethylene (PTFE) binder, a styrene-butadiene rubber (SBR)-based binder, a carboxymethyl cellulose (CMC), a polyacrylic acid-based binder, and a poly(3,4-ethylenedioxythiophene) (PEDOT)-based binder. Particularly, the binder may include a polytetrafluoroethylene (PTFE) binder.

The conductive material may be added to enhance conductivity of the electrode sheet and/or mobility of lithium ions or electrons. For example, the conductive material may include carbon-based conductive materials such as black lead, carbon black, acetylene black, ketjen black, graphene, graphite, carbon nanotubes, vapor-grown carbon fiber (VGCF), carbon fibers, etc., and/or metal-based conductive materials including perovskite materials such as tin, stannic oxide, titanium oxide, LaSrCoO₃, and LaSrMnO₃, but is not limited thereto.

According to an exemplary embodiment, the electrode active material may include a positive electrode active material. The positive electrode active material may include lithium-nickel metal oxide. The lithium-nickel metal oxide may further include at least one of cobalt (Co), manganese (Mn), or aluminum (AI).

According to an embodiment, the mixing device 110 may include at least one of kneader or batch mixer.

According to an embodiment, the batch mixer may represent a mixing device that uniformly mixes a predetermined amount of material using blades.

According to an embodiment, the first fiberization may be determined by shear force applied to the electrode powder by the mixing device.

According to an embodiment, the kneader may represent a mixing device capable of using the blades to mix highly viscous materials by applying relatively high shear force and compressive force. According to an embodiment, the kneader may largely apply the shear force and compressive force to the input material rather than the batch mixer, a jet mill, and a twin-screw extruder. According to an embodiment, the batch mixer may largely apply shear force and compressive force to the input material rather than the jet mill and the twin-screw extruder.

According to an embodiment, the jet mill may represent a mixing device that uses a high-speed compressed gas to allow the materials to collide with each other, thereby mixing and/or grinding the materials. According to an embodiment, the jet mill may include a classifier so that only materials of particles, each of which has a preset size, are discharged to the outside, and materials having particles, each of which has a size greater than the preset size, are crushed.

According to an embodiment, the twin-screw extruder may represent a mixing device in which two screws are engaged with each other or rotate independently while mixing, heating, compressing, and/or moving materials.

According to an embodiment, the kneader may mix the electrode active material, the conductive material, and the binder for a first temperature, at a first speed, and for a first time.

According to an embodiment, the first temperature may range of about 20 °C to about 150 °C. At the temperature range, the fibrous binder may be dispersed on the surfaces of the particles of the electrode active material to bond the particles to each other and maintain the sheet shape when forming the electrode sheet. When mixed at a temperature below about 20 °C, the binder may not undergo the fiberization. When mixed at a temperature above about 150 °C, the fiberization of the binder occurs rapidly, and subsequently, the already formed fibers may be cut off by the high shear force. More specifically, the first temperature may range of about 40 °C to about 150 °C, of about 60 °C to about 150 °C, or of about 80 °C to about 150 °C.

According to an embodiment, the first speed may range of about 5 rpm to about 100 rpm. When the speed is less than about 5 rpm, a sufficient shear pressure may not be provided, and thus the fiberization of the binder may not occur sufficiently. When the first speed exceeds about 100 rpm, there is no additional effect on enhancing the fiberization of the binder, instead, it may cause a limitation that leads to breakage of the electrode sheet. More specifically, according to an embodiment, the first speed may range of about 5 rpm to about 80 rpm, of about 5 rpm to about 60 rpm, of about 5 rpm to about 40 rpm, or of about 5 rpm to about 20 rpm.

According to an embodiment, the first time may range of 30 seconds to 10 minutes. When the first time is less than about 30 seconds, a sufficient shear pressure may not be provided, and thus, the fiberization of the binder may not occur sufficiently. When the first speed exceeds about 10 minutes, there is no additional effect on enhancing the fiberization of the binder, instead, it may cause a limitation that leads to breakage of the electrode sheet. More specifically, according to an embodiment, the first time may range of about 30 seconds to about 8 minutes, of about 30 seconds to about 6 minutes, of about 30 seconds to about 4 minutes, or of about 30 seconds to about 2 minutes.

According to an embodiment, the batch mixer may mix the electrode active material, the conductive material, and the binder for a second time, at a second temperature, at a second speed, and for a second time.

According to an embodiment, the second temperature may range of about 20 °C to about 80 °C. At the temperature range, the fibrous binder may be dispersed on the surfaces of the particles of the electrode active material to bond the particles to each other and maintain the sheet shape when forming the electrode sheet. More specifically, the second temperature may range of about 20 °C to about 70 °C, of about 20 °C to about 60 °C, or of about 20 °C to about 50 °C.

According to an embodiment, the second speed may range of about 5,000 rpm to about 10,000 rpm. When the second speed is less than about 5,000 rpm, a sufficient shear pressure may not be provided, and thus, the fiberization of the binder may not occur sufficiently. When the second speed exceeds about 10,000 rpm, there is no additional effect on enhancing the fiberization of the binder, instead, it may cause a limitation that leads to breakage of the electrode sheet. More specifically, according to an embodiment, the second speed may range of about 6,000 rpm to about 10,000 rpm, of about 7,000 rpm to about 10,000 rpm, or of about 8,000 rpm to about 10,000 rpm.

According to an embodiment, the second time may range of about 1 minute to about 10 minutes. When the time is less than about 1 minute, a sufficient shear pressure may not be provided, and thus, the fiberization of the binder may not occur sufficiently. When the speed exceeds about 10 minutes, there is no additional effect on enhancing the fiberization of the binder, instead, it may cause a limitation that leads to breakage of the electrode sheet. More specifically, according to an embodiment, the second time may range of about 1 minute to about 8 minutes, of about 1 minute to about 6 minutes, of about 1 minute to about 4 minutes, or of about 1 minute to about 2 minutes.

In an embodiment, the electrode powder manufactured by the mixing device 110 under the conditions such as the mixing time, speed, temperature, and pressure may have the first fiberization.

Hereinafter, with reference to FIG. 2, the fiberization of the electrode powder will be described.

FIG. 2 is a graph for explaining a flow function and cohesion strength.

According to an embodiment, the fiberization may represent an index that quantifies a degree of progression of the fiberization of the electrode powder. The higher the degree of the fiberization of the electrode powder, the higher the degree of the fiberization of the electrode powder.

In an embodiment, the first fiberization may represent a degree of fiberization of the electrode powder to be input to the calendering device 150. In more detail, in the case of the electrode powder having fiberization lower than that of the first electrode powder, there may be a limitation in which the tensile strength of the electrode sheet obtained from the electrode powder is significantly low.

According to an embodiment, the fiberization may be defined as a numerical value quantified according to a flow function ffc and/or cohesion strength of the electrode powder. Thus, the electrode powder having the preset fiberization may represent an electrode powder having a preset flow function and/or preset cohesion strength.

In an embodiment, the flow function ffc and the cohesion strength may be measured by a Powder Rheometer device manufactured by Anton Paar. The Powder Rheometer device may measure a flow function ffc and cohesion strength by applying shear stress to the electrode powder.

According to an embodiment, the flow function may represent a value obtained by dividing major principal stress by yield strength. The flow function may represent an index indicating how well electrode powder particles flows, i.e., how easily bonding force between the particles of the electrode powder is broken.

According to an embodiment, the cohesion strength may be obtained from a Mohr diagram. Referring to FIG. 2, the Mohr diagram may represent a diagram (graph) showing a relationship between vertical stress and shear stress. Here, a horizontal axis may represent the vertical stress, and a vertical axis may represent the shear stress. The cohesion strength may mean a value CS for a point at which a tangent line (yield locus) 230 passing through a Mohr circle 220 for major principal stress 221 and the Mohr circle 210 for unconfined yield strength 211 simultaneously meets the vertical axis. That is, the cohesion strength may represent a value indicating the shear stress when the vertical stress is 0.

According to an embodiment, the lower the flow function, the higher the fiberization. According to an embodiment, the greater the cohesion strength, the higher the fiberization. In this disclosure, the fiberization of electrode powder may be determined by numerical values of the flow function and/or the cohesion strength. That is, there is no need to determine the fiberization of the electrode powder by visual or tactile inspection by a user. Thus, the present disclosure enables accurate determination of the fiberization of the electrode powder. In addition, the fiberization may be analyzed using a differential scanning calorimetry (DSC), which is a method for thermal analysis. However, reliability of this method may decrease when the content of the binder is in a trace amount. Thus, even when the content of the binder is in the trace amount, a degree of progress of the fiberization of the electrode powder may be accurately determined by the flow function or the cohesion strength.

Table 1 below is a table showing fiberization corresponding to the flow function and the cohesion strength. The fiberization is highest in a stage 1, a stage 2 is lower than the stage 1, a stage 3 is lower than each of the stages 1 and 2, a stage 4 is lower than each of the stages 1, 2, and 3, and a stage 5 represents a state in which the fiberization is not progressed and thus shows the lowest fiberization. The numerical ranges set forth in Table 1 below are merely illustrative and are not intended to limit the appended claims, and it is obvious to those skilled in the art that various changes and modifications can be made to the examples within the scope of the disclosure and the spirit of the present disclosure, and it is also obvious that such variations and modifications fall within the scope of the appended claims.

TABLE 1

| Fiberization | Flow function | Cohesion strength [Pa] |
|---|---|---|
| Stage 1 | More than 0 to 1.1 or less | 500 or more to less than 700 |
| Stage 2 | More than 1.1 to 1.4 or less | 300 or more to less than 500 |
| Stage 3 | More than 1.4 to 2.0 or less | 150 or more to less than 300 |
| Stage 4 | More than 2.0 to 4.0 or less | 100 or more to less than 150 |
| Stage 5 | More than 4.0 to 10.0 or less | More than 0 to less than 100 |

According to an embodiment, the first fiberization may be determined by at least one of the flow function and the cohesion strength.

According to an embodiment, the first fiberization may be about 0 to about 4.0, and/or the cohesion strength may be about 100 Pa or more to less than about 700 Pa. That is, the first fiberization may represent a range of the flow function and/or the cohesion strength for the stages 1 to 4.

More specifically, according to an embodiment, the first fiberization may have a flow function of more than about 0 to about 2.0 or less and/or cohesion strength of about 150 Pa or more to less than about 700 Pa. That is, the first fiberization may represent a range of the flow function and/or the cohesion strength for the stages 1 to 3.

More specifically, the first fiberization may be greater than about 0 to about 1.4 or less, and/or the cohesion strength may be about 300 Pa or more to less than about 700 Pa. That is, the first fiberization may represent a range of the flow function and/or the cohesion strength for the stages 1 to 2.

More specifically, when measuring the flow function and the cohesion strength of the electrode powder, if the fiberization corresponding to the flow function of the electrode powder is different from the fiberization corresponding to the cohesion strength of the electrode powder, the fiberization corresponding to the flow function may be determined as the fiberization of the electrode powder. For example, when the flow function of the electrode powder is more than about 1.1 and about 1.4 or less, and the cohesion strength of the electrode powder is about 150 Pa or more and less than about 300 Pa, the fiberization of the electrode powder may be determined as the stage 2, which corresponds to the range of the flow function.

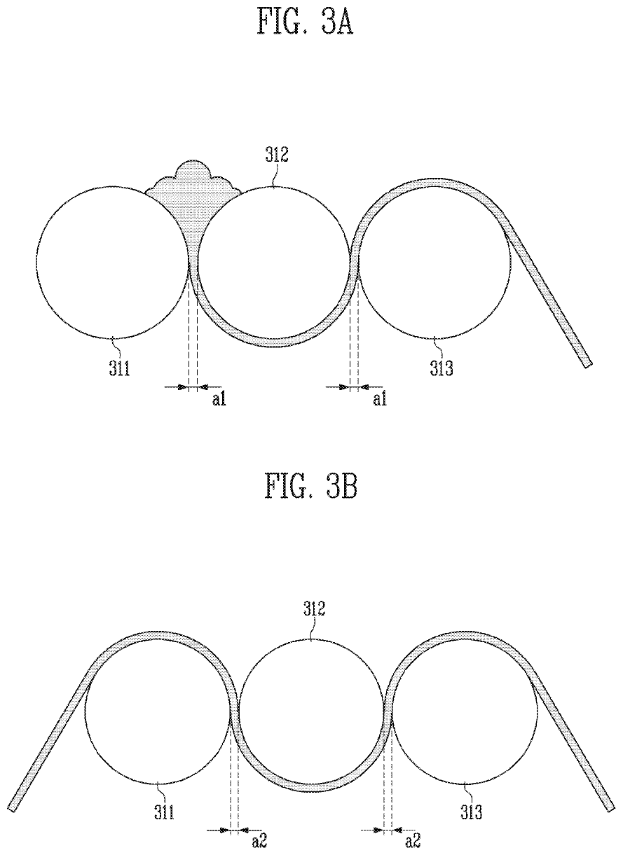

Hereinafter, a method for manufacturing a first electrode sheet from the electrode powder is described with reference to FIG. 3A, and a method for manufacturing a second electrode sheet from the first electrode sheet is described with reference to FIG. 3B.

FIG. 3A is a schematic view illustrating the calendering device for explaining a process of manufacturing the first electrode sheet. FIG. 3B is a schematic view illustrating the calendering device for explaining a process of manufacturing the second electrode sheet.

The electrode powder of the first fiberization may be input into the calendering device 150.

The calendaring device 150 may include a plurality of continuously arranged rolls 311, 312, and 313 that rotate to move the electrode powder while pressing the electrode powder.

The calendering device 150 may represent a device for manufacturing a material input in a sheet shape by a pressure and heat provided by the rotation of the plurality of rolls 311, 312, and 313. For example, the number of plurality of rolls 311, 312, and 313 may be three.

However, this is merely an example, and the number of plurality of rolls 311, 312, and 313 included in the calendering device 150 according to the present disclosure is not limited thereto.

The calendaring device 150 may input the electrode powder into the rolls at a first interval a1. The calendaring device 150 may acquire a first electrode sheet on the basis of the electrode powder input into the rolls 311, 312, and 313 at the first interval a1. For example, the process of acquiring the first electrode sheet from the electrode powder may be referred to as a pre-sheeting process. For example, the first electrode sheet may be referred to as a thick electrode sheet.

According to an embodiment, the first interval a1 may be an interval of more than about 200 μm. More specifically, according to an embodiment, the first interval a1 may be more than about 200 μm and about 5 mm or less. When the first interval a1 exceeds about 5 mm, the pressure applied to the electrode powder may be insufficient, resulting in failure to form the electrode sheet. When the first interval a1 does not exceed about 200 μm, the electrode powder may not be input into the rolls, resulting in failure to form the electrode sheet. In addition, an excessive pressure may be applied to the electrode powder to cause cracks or tearing of the electrode sheet. More specifically, according to an embodiment, the first interval a1 may range of about 400 μm to about 5 mm, about 500 μm to about 5 mm, about 600 μm to about 5 mm, about 700 μm to about 5 mm, about 800 μm to about 5 mm, or about 900 μm to about 5 mm. More specifically, the first interval a1 may be an interval of about 1 mm or more. More specifically, the first interval a1 may range from about 1 mm or more to about 5 mm or less. When the first interval a1 ranges from about 1 mm or more to about 5 mm or less, the first electrode sheet may be formed in the form of a sheet having a large area and may have higher tensile strength. According to an embodiment, in FIG. 3A, an interval between the first roll 311 and the second roll 312 and the interval a1 between the second roll 312 and the third roll 313 are shown as being equal to each other, but these intervals may be set differently from each other. In an embodiment, the calendaring device 150 may acquire the first electrode sheet by roll-pressing the electrode powder at a temperature of about 20 °C to about 200 °C. At the above-described temperature range, the fiberization of the binder may be promoted. As a result, the tensile strength of the electrode sheet manufactured within the temperature range may increase. More specifically, the calendaring device 150 may acquire the first electrode sheet by roll-pressing the electrode powder at a temperature of about 30 °C to about 200 °C, about 40 °C to about 200 °C, or about 50 °C to about 200 °C.

The calendaring device 150 may input the first electrode sheet into the rolls 311, 312, and 313 adjusted to a second interval a2 that is narrower than the first interval a1, thereby manufacturing the second electrode sheet.

According to an embodiment, the second interval a2 may be about 50 μm or more and about 200 μm or less. When the second interval a2 exceeds about 200 μm, a pressure applied to the electrode powder may be insufficient, and thus, it may be impossible to manufacture the electrode sheet that is maintained in its sheet shape without a separate support such as a current collector. When the second interval a2 is less than about 50 μm, an excessive pressure may be applied to the first electrode sheet, resulting in cracks or tearing of the second electrode sheet. More specifically, according to an embodiment, the second interval a2 may be about 100 μm to about 200 μm, or about 150 μm to about 200 μm. According to an embodiment, in FIG. 3B, the interval between the first roll 311 and the second roll 312 and the interval a2 between the second roll 312 and the third roll 313 are shown as being equal to each other, but these intervals may be set differently from each other.

In an embodiment, the calendaring device 150 may acquire the second electrode sheet by roll-pressing the first electrode sheet at a temperature of about 20 °C to about 200 °C. At the above-described temperature range, the fiberization of the binder may be promoted. As a result, the tensile strength of the second electrode sheet manufactured within the temperature range may increase. More specifically, the calendaring device 150 may roll-press the first electrode sheet at a temperature of about 30 °C to about 200 °C, about 40 °C to about 200 °C, or about 50 °C to about 200 °C to acquire the second electrode sheet.

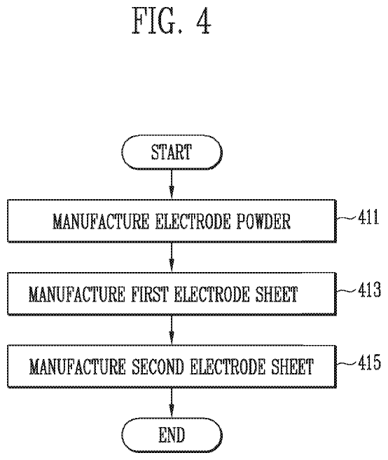

FIG. 4 is a flowchart illustrating a method for manufacturing an electrode sheet using a system for manufacturing the electrode sheet according to the present disclosure.

Referring to FIG. 4, the method for manufacturing the electrode sheet using the system 100 for manufacturing the electrode sheet according to the present disclosure may include a process 411 of manufacturing electrode powder having first fiberization by mixing an electrode active material, a binder, and a conductive material using a mixing device 110.

According to an embodiment, with respect to 100 parts by weight of the electrode powder, the electrode active material may be mixed in an amount of about 93 parts to about 97 parts by weight, the conductive material may be mixed in an amount of about 2 parts to 4 parts by weight, and the binder may be mixed in an amount of about 1 part to 3 parts by weight.

According to an embodiment, the mixing device 110 may include at least one kneader or batch mixer.

According to an embodiment, the process 411 of manufacturing the electrode powder may include a process of mixing the electrode active material, the conductive material, and the binder at a first temperature and at a first speed for a first time using a kneader. According to an embodiment, the first temperature may range of about 20 °C to about 150 °C. According to an embodiment, the first speed may range of about 5 rpm to about 100 rpm. According to an embodiment, the first time may range of 30 seconds to 10 minutes.

According to an embodiment, the process 411 of manufacturing electrode powder may include a process of mixing the electrode active material, the conductive material, and the binder at a second temperature and at a second speed for a second time using the batch mixer. According to an embodiment, the second temperature may range of about 20 °C to about 80 °C. According to an embodiment, the second speed may range of about 5,000 rpm to about 10,000 rpm. According to an embodiment, the second time may range of about 1 minute to about 10 minutes.

According to an embodiment, the first fiberization may be defined as a numerical value quantified according to a flow function and/or cohesion strength of the electrode powder. The first fiberization may have a flow function of about more than 0 to about 1.4 or less and/or cohesion strength of about 300 Pa or more to less than about 700 Pa.

According to an embodiment, the method for manufacturing the electrode sheet using the system 100 for manufacturing the electrode sheet according to the present disclosure may include a process (413) of manufacturing the first electrode sheet by inputting the electrode powder to a plurality of rolls, each of which has a first pitch, of the calendering device 150. For example, the first interval may be more than about 200 μm and about 5 mm or less.

According to an embodiment, the method for manufacturing the electrode sheet using the system 100 for manufacturing the electrode sheet according to the present disclosure may include a process (415) of manufacturing a second electrode sheet by inputting the first electrode sheet into rolls, each of which has a second interval that is narrower than the first interval at the first interval. For example, the second interval may be about 50 μm or more and about 200 μm or less.

According to an embodiment, an electrode sheet (second electrode sheet) may be manufactured by the method for manufacturing the electrode sheet. The electrode sheet (second electrode sheet) may be manufactured from the electrode powder having the first fiberization.

Hereinafter, embodiments of the present disclosure will be further described with reference to specific examples. Experimental examples are merely illustrative of the present disclosure and are not intended to limit the appended claims. It is obvious to those skilled in the art that various changes and modifications can be made to the examples within the scope of the disclosure and the spirit of the present disclosure, and it is also obvious that such variations and modifications fall within the scope of the appended claims.

### Manufacture of Electrode Powder

In Embodiments 1 and 2 and Comparative Examples 1 to 3 below, an electrode powder was manufactured by mixing natural graphite, graphite, and polytetrafluoroethylene (PTFE). In Embodiments 1 and 2 and Comparative Examples 1 to 3 below, with respect to 100 parts by weight of the electrode powder, about 95.8 parts by weight of natural graphite, about 3 parts by weight of graphite, and about 1.2 parts by weight of polytetrafluoroethylene (PTFE) were mixed.

### Embodiment 1

The electrode powder was manufactured using a kneader under mixing conditions of about 100 °C, about 10 rpm, and about 1 minute.

### Embodiment 2

The electrode powder was manufactured using a batch mixer under mixing conditions of room temperature, about 9,000 rpm, and about 1 minute.

### Comparative Example 1

The electrode powder was manufactured using a jet mill under mixing conditions of room temperature, about 0.2 mPa, and about 1 minute.

### Comparative Example 2

The electrode powder was manufactured using a twin-screw extruder under mixing conditions of about 80 °C, about 1,000 rpm, and a discharge rate (flow rate) of about 30 kg/hr.

### Comparative Example 3

The electrode powder was manufactured under mixing conditions of room temperature, about 15 rpm, and about 15 minutes using a planetary despa mixer (PD mixer).

The mixing devices, powder shapes, flow functions, and cohesion strength according to Embodiments 1 and 2 and Comparative Examples 1 to 3 were described in Table 2 below.

The flow functions and the cohesion strength according to Embodiments 1 to 2 and Comparative Examples 1 to 3 were measured using a Powder Rheometer device manufactured by Anton Paar. In a pre-shear section, vertical stress of 1 kPa was applied to the electrode powder. After the pre-shear section, shear stress at a first point at which vertical stress of about 0.1 kPa is applied to the electrode powder, shear stress at a second point after the first point at which vertical stress of about 0.3 kPa is applied to the electrode powder, and shear stress at a third point after the second point at which vertical stress of about 0.5 kPa is applied to the electrode powder were measured. A yield locus connecting the vertical stress and the shear stress at the first point, the vertical stress and the shear stress at the second point, and the vertical stress and the shear stress at the third point was acquired.

TABLE 2

| | | Electrode | | Cohesion |
|---|---|---|---|---|
| | | powder | Flow | strength |
| Item | Mixing device | shape | function | (Pa) |
| Embodiment 1 | Kneader | Kneading type | 1.1 | 528.1 |
| Embodiment 2 | Batch mixer | Cohesion type | 1.27 | 318.1 |
| Comparative | Jet Mill | Cohesion type | 1.43 | 328.0 |
| Example 1 | | | | |
| Comparative | Twin screw | Granular type | 1.72 | 195.8 |
| Example 2 | extruder | | | |
| Comparative | PD mixer | Powder type | 3.72 | 131.5 |
| Example 3 | | | | |

The shapes of the electrode particles described in Table 2 represent shapes of the electrode particles visually observed. The kneading type electrode powder represents a state in which a mixture mass is being formed. The cohesion type electrode powder represents a state in which a mixture mass is formed with a lower degree of fiberization compared to the kneading type electrode powder. The granular type electrode powder represents a state in which a mixture mass is formed with lower fiberization compared to the cohesion type electrode powder and hard particles. The granular type electrode powder may be in a granule state. The powder type electrode powder represents a state in which a mixture mass is formed with a lower degree of fiberization compared to the granular type electrode powder and a particle size less than that of the granular type electrode powder. The powder type electrode powder may be in a powder state.

As seen from Table 2 above, it was confirmed that the electrode powder manufactured according to Embodiment 1 has the lowest flow function and the highest cohesion strength. That is, it was confirmed that the electrode powder manufactured according to Embodiment 1 has the highest fiberization.

It was confirmed that the electrode powder manufactured according to Embodiment 2 has lower fiberization than that in Embodiment, and higher fiberization than that in Comparative Examples 1 to 3. It was confirmed that the electrode powder manufactured according to Comparative Example 1 has lower fiberization than that in Embodiments 1 and 2 and higher fiberization than that in Comparative Examples 2 and 3.

It was confirmed that the electrode powder manufactured according to Comparative Example 2 has lower fiberization than that in Embodiments 1 and 2 and higher fiberization than that in Comparative Example 1.

It was confirmed that the electrode powder manufactured according to Comparative Example 3 has the highest flow function and the lowest cohesion strength. That is, it was confirmed that the fiberization of the electrode powder manufactured according to Comparative Example 3 is the lowest. That is, referring to Embodiments 1 and 2 and Comparative Examples 1 to 3, it was seen that the fiberization of the electrode powder manufactured by the mixing devices varies depending on the types of the mixing device. This is because magnitudes of the shear force provided by the mixing devices are different from each other. Since the Kneader and the batch mixer provide greater shear force compared to the jet mill, the twin screw extruder, and the PD mixer, it was seen that the fiberization of the electrode powder manufactured according to Embodiments 1 and 2 is greater than that of the electrode powder manufactured according to Comparative Examples 1 and 3.

### Manufacture of Electrode Sheet

### Embodiment 3

Three rolls were arranged in sequence, and the electrode powder manufactured according to Embodiment 1 was input into the calendering device at a temperature of about 50 °C to manufacture an electrode sheet. An interval between the three rolls is about 2 mm.

The acquired electrode sheet was input into the calendering device set at the temperature of about 50 °C to manufacture a final electrode sheet. Here, an interval between the first roll 311 and the second roll 312 is about 130 μm, and an interval between the second roll 312 and the third roll 313 is about 100 μm (see FIG. 3B).

### Embodiment 4

Three rolls were arranged in sequence, and the electrode powder manufactured according to Embodiment 2 was input into the calendering device at a temperature of about 50 °C to manufacture an electrode sheet. An interval between the three rolls is about 2 mm.

The acquired electrode sheet was input into the calendering device set at the temperature of about 50 °C to manufacture a final electrode sheet. Here, an interval between the first roll 311 and the second roll 312 is about 130 μm, and an interval between the second roll 312 and the third roll 313 is about 100 μm (see FIG. 3B).

### Comparative Example 4

The electrode powder manufactured according to Embodiment 1 was ground and deagglomerated. Three rolls were arranged in sequence, and the deagglomerated electrode powder was input into the rolls of the calendering device, which has the temperature of about 50 °C, to manufacture an electrode sheet. Here, an interval between the first roll 311 and the second roll 312 is about 130 μm, and an interval between the second roll 312 and the third roll 313 is about 100 μm (see FIG. 3B).

### Comparative Example 5

Three rolls were arranged in sequence, and the electrode powder manufactured according to Embodiment 2 was input into the calendering device at a temperature of about 50 °C to manufacture a final electrode sheet. Here, an interval between the first roll 311 and the second roll 312 is about 130 μm, and an interval between the second roll 312 and the third roll 313 is about 100 μm (see FIG. 3B).

### Comparative Example 6

Three rolls were arranged in sequence, and the electrode powder manufactured according to Comparative Example 1 was input into the calendering device at a temperature of about 50 °C to manufacture a final electrode sheet. Here, an interval between the first roll 311 and the second roll 312 is about 130 μm, and an interval between the second roll 312 and the third roll 313 is about 100 μm (see FIG. 3B).

### Comparative Example 7

Three rolls were arranged in sequence, and the electrode powder manufactured according to Comparative Example 2 was input into the calendering device at a temperature of about 50 °C to manufacture a final electrode sheet. Here, an interval between the first roll 311 and the second roll 312 is about 130 μm, and an interval between the second roll 312 and the third roll 313 is about 100 μm (see FIG. 3B).

### Comparative Example 8

Three rolls were arranged in sequence, and the electrode powder manufactured according to Comparative Example 3 was input into the calendering device at a temperature of about 50 °C to manufacture a final electrode sheet. Here, an interval between the first roll 311 and the second roll 312 is about 130 μm, and an interval between the second roll 312 and the third roll 313 is about 100 μm (see FIG. 3B).

### Comparative Example 9

Three rolls are arranged in sequence, and the electrode powder manufactured according to Embodiment 1 is disposed in the rolls of the calendering device, which has the temperature of about 50 °C, but the electrode powder was not input into the rolls. Here, an interval between the first roll 311 and the second roll 312 is about 130 μm, and an interval between the second roll 312 and the third roll 313 is about 100 μm (see FIG. 31B).

The mixing devices according to Embodiments 3 and 4, and Comparative Examples 4 to 9, whether the pre-sheeting process is performed, and the tensile strength were written in Table 3 below. The pre-sheeting process refers to a process in which the electrode powder is input into the calendering device with an interval of about 2 mm between the rolls before acquiring the final electrode sheet.

The tensile strength was measured using a UTM tester. A size of a specimen of the final electrode sheet was manufactured with dimensions of about 12.7 mm in width and about 100 mm in length.

TABLE 3

| | Mixing | | Whether pre-sheeting | Tensile strength of |
|---|---|---|---|---|
| Item | device | Powder shape | process is performed | electrode sheet (MPa) |
| Embodiment 3 | Kneader | Kneading type | Progress | 1.85 |
| Embodiment 4 | Batch mixer | Cohesion type | Progress | 1.23 |
| Comparative | Kneader | Kneading type | Non-progress | 0.93 |
| Example 4 | | | | |
| Comparative | Batch mixer | Cohesion type | Non-progress | 0.68 |
| Example 5 | | | | |
| Comparative | Jet Mill | Cohesion type | Non-progress | 0.25 |
| Example 6 | | | | |
| Comparative | Twin screw | Granular type | Non-progress | — |
| Example 7 | extruder | | | |
| Comparative | PD mixer | Powder type | Non-progress | — |
| Example 8 | | | | |
| Comparative | Kneader | Kneading type | Non-progress | — |
| Example 9 | | | | |

In Embodiments 3 and 4, the tensile strength of the final electrode sheet manufactured when two calendering processes including the pre-sheeting process are performed was compared. It was confirmed that the tensile strength of the electrode sheet according to Embodiment 3 is greater than that of the electrode sheet according to Embodiment 4. Since the shear force applied to the electrode powder by the Kneader is greater than the shear force applied to the electrode powder by the batch mixer, it was seen that the fiberization of the binder included in the electrode sheet manufactured according to Embodiment 3 is greater than the fiberization of the binder included in the electrode sheet manufactured according to Embodiment 4. That is, it was seen that the higher the fiberization of the binder, the greater the tensile strength of the electrode sheet.

Comparing Embodiment 3 with Comparative Example 4, it was seen that the tensile strength of Embodiment 3 is greater than that of Comparative Example 4. Comparing Embodiment 4 with Comparative Example 5, it was seen that the tensile strength of Embodiment 4 is greater than that of Comparative Example 5. It was seen that, even though the electrode sheets is manufactured using the same mixing device, since additional shear force is applied to the electrode powder during the pre-sheeting process, two calendering processes including the pre-sheeting process is performed to promote the fiberization of the binder contained in the finally acquired electrode sheet.

In Embodiment 3, two calendering processes including the pre-sheeting process is performed without performing a process of grinding the electrode powder with high fiberization. In Comparative Example 9, the process of grinding the electrode powder with the high fiberization was not performed, and thus, the electrode powder were not input into the rolls. As a result, it was seen that, even for the electrode powder with the high fiberization, the process of grinding the electrode powder is not necessary to manufacture the electrode sheet if the pre-sheeting process is performed.

In Comparative Examples 6 to 8, the tensile strength of the final electrode sheet manufactured by performing the one calendering process without performing the pre-sheeting process on the electrode powder manufactured using the mixing devices that are different from each other was compared. In the case of Comparative Example 6, although it was formed in the form of the sheet, it was difficult to maintain its large area, and a portion of an end was torn. In the case of Comparative Example 7, the tensile strength was very low, and thus, it was difficult to measure the tensile strength. Although the sheet shape was formed, it could not be maintained, the folding and tearing at the end occurred, and the material was prone to damage due to external force. In Comparative Example 8, the sheeting was not performed, and the material was maintained as the electrode powder. In this regard, in Comparative Examples 6 to 8, since sufficient tensile force was not provided to the electrode powder, the fiberization of the binder was not sufficiently carried out. As a result, the electrode powder was not sufficiently agglomerated, resulting in a thin thickness of the surface of the electrode sheet. Thus, in the case of Comparative Examples 6 to 8, if the pre-sheeting process is also performed, the thickness of the electrode sheet may become even thinner to lead to the problem of surface tearing.

When manufacturing the electrode sheet from the electrode powder corresponding to the stages 3 to 5 of the fiberization, the electrode sheet with low tensile strength may be acquired, and the thickness of the electrode sheet may become so thin, and thus, it is unable to maintain its sheet shape without the separate support. In addition, since the particles of the electrode powder are not agglomerated with each other, the sheeting may be impossible. Furthermore, when the pre-sheeting process is performed on the electrode powder with the stage 3 to the stage 5 of the fiberization, there may be a limitation in which the surface of the electrode sheet becomes more prone to tearing compared to the electrode sheet for which the pre-sheeting process has not been performed on the electrode powder with the stage 3 to the stage 5 of the fiberization.

As described above, it is preferable in that the tensile strength of the electrode sheet increases when the electrode sheet is manufactured by performing the one calendering process (pre-sheeting process) on the electrode powder corresponding to the stage 1 and the stages 2 of the fiberization and then performing the two calendering process after the first calendering process. Furthermore, the electrode powder corresponding to the stages 1 and 2 has relatively high fiberization to allow the particles of the electrode powder to be agglomerated with each other. Thus, in the one calendering process (pre-sheeting process), it is preferable to relatively increase in interval between the rolls to input the electrode slurry between the rolls. Furthermore, if the electrode powder is subjected to the pre-sheeting process for the electrode powder corresponding to the steps 1 and 2, the process of grinding the electrode powder to manufacture the electrode sheet may be omitted.

### Evaluation of Flow Function—Types of Mixing Devices

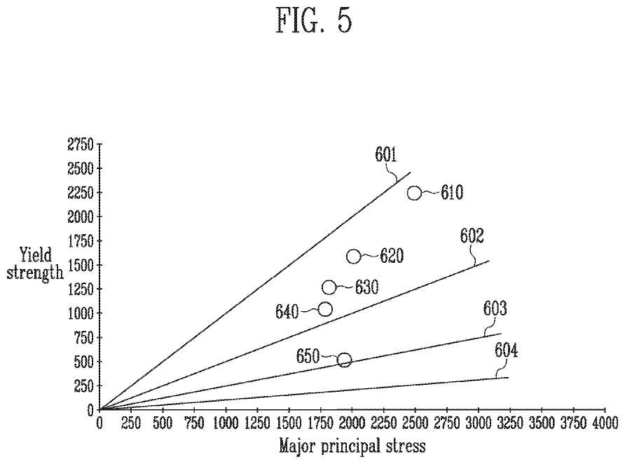

FIG. 5 is a graph for explaining a correlation between types of the mixing device and the flow function.

Referring to FIG. 5, a horizontal axis of the graph may represent major principal stress, and a vertical axis may represent yield strength. The graph above shows flow function of Embodiment 1 (610), Embodiment 2 (620), Comparative Example 1 (630), Comparative Example 2 (640), and Comparative Example 3 650).

Each of a first reference line 601, a second reference line 602, a third reference line 603, and a fourth reference line 604 shown in the graph of FIG. 5 represents a reference line for a ratio of yield strength to major principal stress. The first reference line 601 represents a reference line indicating that a flow function ffc is 1. The second reference line 602 represents a reference line indicating that the flow function ffc is 2. The third reference line 603 represents a reference line indicating that the flow function ffc is 4. The fourth reference line 604 represents a reference line indicating that the flow function ffc is 10. For example, an area having a flow function ffc smaller than that of the first reference line 601 is referred to as a “not-flowing” area, an area having a flow function ffc between the first reference line 601 and the second reference line 602 is referred to as a “very cohesive” area, an area having a flow function ffc between the second reference line 602 and the third reference line 603 is referred to as a “cohesive” area, an area having a flow function ffc between the third reference line 603 and the fourth reference line 604 is referred to as an “easy flowing” area, and an area having a flow function ffc larger than that of the fourth reference line 604 is referred to as a “free-flowing” area.

The flow function of Embodiment 1 (610) is the smallest, and the flow function of Embodiment 2 (620) is smaller than that of each of Comparative Examples (630, 640, and 650) other than Embodiment 1 (610). The flow function decreases in order of Comparative Example 3 (650), Comparative Example 2 (640), Comparative Example 1 (630), Embodiment 2 (620), and Embodiment 1 (610).

That is, it is seen that the flow function of the manufactured electrode powder varies depending on the types of the mixing device. It is considered that this is because magnitudes of the shear force provided by the mixing devices are different from each other. Since the Kneader provides the highest shear force compared to the batch mixer, the jet mill, the twin screw extruder, and the PD mixer, it is seen that the flow function of the electrode powder manufactured using the Kneader is the smallest. Thus, there is a correlation between the types of mixing device and the flow function of the electrode powder.

### Evaluation of Flow Function—Particle Size of Electrode Powder

The flow function of the electrode powder was evaluated using the above-described electrode powder of Embodiment 2 by classifying the electrode powder according to the particle size without classification and by classifying the electrode powder according to the particle size using each of mesh sizes of about 500 μm, about 850 μm, about 1 mm, and about 2 mm.

The flow function of the electrode powder was measured by a Powder Rheometer device manufactured from Anton Paar. In a pre-shear section, vertical stress of 1 kPa was applied to the electrode powder. After the pre-shear section, shear stress at a first point at which vertical stress of about 0.1 kPa is applied to the electrode powder, shear stress at a second point after the first point at which vertical stress of about 0.3 kPa is applied to the electrode powder, and shear stress at a third point after the second point at which vertical stress of about 0.5 kPa is applied to the electrode powder were measured. A yield locus connecting the vertical stress and the shear stress at the first point, the vertical stress and the shear stress at the second point, and the vertical stress and the shear stress at the third point was acquired.

Table 4 below shows the results of evaluating the flow function of the electrode powder depending on the particle sizes.

TABLE 4

| Particle size | Electrode powder shape | Flow function |
|---|---|---|
| Non classification | Cohesion type | 1.27 |
| 500 μm | Spherical shape | 1.40 |
| 850 μm | Spherical shape | 1.26 |
| 1 mm | Spherical shape | 1.21 |
| 2 mm | Spherical shape | 1.35 |

Referring to Table 4, the particle shapes of the electrode powder classified according to the particle size by varying the mesh sizes of the mesh are spherical. The spherical shape may have particles having uniform size.

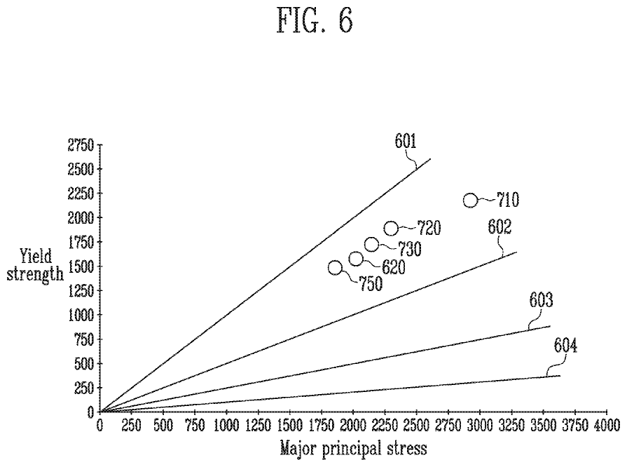

FIG. 6 is a graph for explaining a correlation between the particle size and the flow function of the electrode powder.

Referring to FIG. 6 and Table 4, the flow functions of the experimental example 620 (not classified according to the particle sizes), the experimental example 730 (classified according to a particle size of about 500 μm), the experimental example 750 (classified according to a particle size of about 850 μm), the experimental example 720 (classified according to a particle size of about 1 mm), and the experimental example 710 (classified according to a particle size of about 2 mm) have values within the same critical range (about 10 percent). It was seen that, under the mixing conditions in which types of the mixing device, mixing temperatures, mixing times, and mixing speeds were all the same, the fiberization was the same or within the critical range, regardless of the particle sizes of the electrode powder. Therefore, it is seen that there is no correlation between the particle size of the electrode powder and the fiberization of the electrode powder.

### Evaluation of Flow Function—Measured Temperature

The flow function of the electrode powder was evaluated using Comparative Example 3 by varying the temperatures at about 0 °C, about 25 °C, about 40 °C, about 60 °C, about 80 °C, about 100 °C, and about 120 °C.

The flow function of the electrode powder was measured by a Powder Rheometer device manufactured from Anton Paar. In a pre-shear section, vertical stress of 1 kPa was applied to the electrode powder. After the pre-shear section, shear stress at a first point at which vertical stress of about 0.1 kPa is applied to the electrode powder, shear stress at a second point after the first point at which vertical stress of about 0.3 kPa is applied to the electrode powder, and shear stress at a third point after the second point at which vertical stress of about 0.5 kPa is applied to the electrode powder were measured. A yield locus connecting the vertical stress and the shear stress at the first point, the vertical stress and the shear stress at the second point, and the vertical stress and the shear stress at the third point was acquired.

Table 5 below shows the results of evaluating the flow function of electrode powder at various temperatures.

TABLE 5

| Measured temperature (°C) | Flow function |
|---|---|
| 0 | 3.48 |
| 25 | 3.04 |
| 40 | 3.72 |
| 60 | 3.7 |
| 80 | 3.68 |
| 100 | 3.68 |
| 120 | 3.97 |

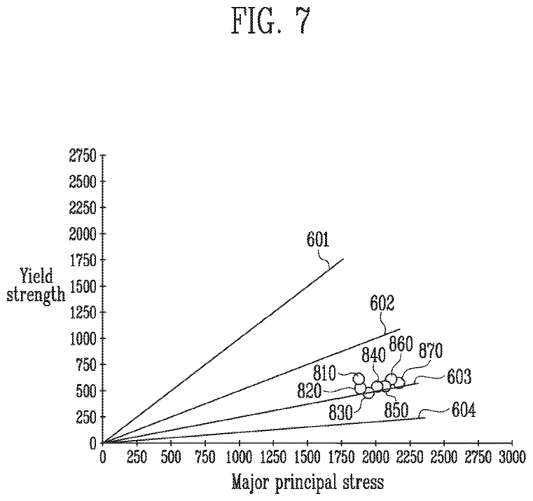

FIG. 7 is a graph for explaining a correlation between a measured temperature and the flow function of electrode powder.

FIG. 7 illustrates an experimental example 860 when the measured temperature is about 0 °C, an experimental example 810 when the measured temperature is about 25 °C, an experimental example 850 when the measured temperature is about 40 °C, an experimental example 820 when the measured temperature is about 60 °C, an experimental example 870 when the measured temperature is about 80 °C, an experimental example 840 when the measured temperature is about 100 °C, and an experimental example 830 when the measured temperature is about 120 °C.

Referring to Table 5 and FIG. 7, since the differences in flow function of the experimental examples 810, 820, 830, 840, 850, 860, and 870 are within the critical range (about 10 percent), it is confirmed that the flow functions of the experimental examples 810, 820, 830, 840, 850, 860, and 870 are the same or similar to each other. That is, it is confirmed that the fiberization of the electrode powder is independent of the temperature of the measuring device used to measure the flow function. Therefore, it is seen that there is no correlation between the temperature of the measuring device and the flow function of the electrode powder.

According to an embodiment of the present disclosure, the quality of the electrode sheet may be improved.

According to another embodiment of the present disclosure, the fiberization of the electrode powder may be quantified.

According to another embodiment of the present disclosure, the process of manufacturing the electrode sheet may be simplified.

According to another embodiment of the present disclosure, the properties of the electrode sheet may be improvised.

According to another embodiment of the present disclosure, the tensile strength of the electrode sheet may increase.

According to another embodiment of the present disclosure, the manufacturing costs of the electrode sheet may be reduced.

The present disclosure may be modified in various forms, and thus the scope of the present disclosure is not limited to the above-described embodiments. Therefore, if the modified embodiment includes the components of the claims of the present disclosure, it should be considered to fall within the scope of the claims of the present disclosure.

What is claimed is:

1. A method for manufacturing an electrode sheet, the method comprising:
manufacturing electrode powder with first fiberization by mixing an electrode active material, a conductive material, and a binder using a mixing device;
manufacturing a first electrode sheet by inputting the electrode powder into a plurality of rolls at a first interval of about 1 mm or more; and
manufacturing a second electrode sheet by inputting the first electrode sheet onto the plurality of rolls at a second interval of about 200 μm or less, which is narrower than the first interval.

2. The method of claim 1, wherein the first fiberization is determined by a flow function (ffc) of the electrode powder.

3. The method of claim 2, wherein the flow function comprises more than about 0 to about 1.4 or less.

4. The method of claim 1, wherein the first fiberization is determined by cohesion strength of the electrode powder.

5. The method of claim 4, wherein the cohesion strength comprises about 300 Pa or more and less than about 700 Pa.

6. The method of claim 1, wherein the first fiberization is determined by shear force applied to the electrode powder by the mixing device.

7. The method of claim 1, wherein the mixing device comprises a kneader, and
the manufacturing of the electrode powder comprises mixing the electrode active material, the conductive material, and the binder at a first temperature, at a first speed, and for a first time by using the kneader.

8. The method of claim 7, wherein the first temperature ranges of about 20 °C to about 150 °C,
the first speed ranges of about 5 rpm to about 100 rpm, and
the first time ranges of about 30 seconds to about 10 minutes.

9. The method of claim 1, wherein the mixing device comprises a batch mixer, and
the manufacturing of the electrode powder comprises mixing the electrode active material, the conductive material, and the binder at a second temperature, at a second speed, and for a second time by using the batch mixer.

10. The method of claim 9, wherein the second temperature ranges of about 20 °C to about 80 °C,
the second speed ranges of about 5,000 rpm to about 10,000 rpm, and
the second time ranges of about 1 minute to about 10 minutes.

11. The method of claim 1, wherein, with respect to 100 parts by weight of the electrode powder, the electrode active material has about 93 parts to about 97 parts by weight, the conductive material has about 2 parts to about 4 parts by weight, and the binder has about 1 part to about 3 parts by weight.

12. The method of claim 1, wherein the first interval ranges from about 1 mm or more to about 5 mm or less.

13. The method of claim 1, wherein the second interval ranges from about 50 μm or more to about 200 μm or less.

14. An electrode sheet manufactured according to the method of claim 1.

15. The electrode sheet of claim 14, wherein the electrode sheet is manufactured by processing electrode powder having first fiberization into a sheet form,
wherein the first fiberization is determined by one or more of flow functions of the electrode powder and cohesion strength of the electrode powder,
wherein the flow functions range of more than about 0 to about 1.4 or less, and the cohesion strength ranges of about 300 Pa or more and less than about 700 Pa.
